(19) United States
(12) Patent Application Publication
(10) Pub. No.: US 2017/0137087 A1
(43) Pub. Date: May 18, 2017

(54) BICYCLE DRIVE UNIT

(71) Applicant: Shimano Inc., Osaka (JP)

(72) Inventor: Etsuyoshi WATARAI, Osaka (JP)

(21) Appl. No.: 15/336,550

(22) Filed: Oct. 27, 2016

(30) Foreign Application Priority Data
Nov. 16, 2015 (JP) 2015-223963

(51) Int. Cl. B62M 6/55; B62M 11/00; B62M 6/45; B62M 9/00

(52) U.S. Cl. CPC B62M 6/55; B62M 9/00; B62M 11/00; B62M 6/45

(57) ABSTRACT

A bicycle drive unit includes a housing, an output unit, a first motor and a second motor. The housing rotatably support a crankshaft. The output unit is provided in the housing and to which rotation of the crankshaft is transmitted. The first motor is provided in the housing that can assist a manual drive force without changing the ratio of the rotational speed of the output unit relative to the rotational speed of the crankshaft. The second motor is provided in the housing to assist the manual drive force without changing the ratio of the rotational speed of the output unit relative to the rotational speed of the crankshaft.

### CROSS-REFERENCE TO RELATED APPLICATIONS

This application claims priority to Japanese Patent Application No. 2015-223963, filed on Nov. 16, 2015. The entire disclosure of Japanese Patent Application No. 2015-223963 is hereby incorporated herein by reference.

### BACKGROUND

Field of the Invention

The present invention relates to a bicycle drive unit.

Background Information

Some bicycles are provided with a bicycle drive unit to assist the rider by generating an auxiliary drive force. A bicycle drive unit comprises a motor that assists a manual drive force that is applied to a crankshaft of a bicycle. In addition to the motor, the bicycle drive unit often further comprises a reduction gear that decelerates the rotation of the motor and transmits the rotation to an output unit that is coupled to a front sprocket. One example of such a conventional bicycle drive unit is disclosed in Japanese Patent No. 5,575,938.

### SUMMARY

Generally, the present disclosure is directed to various features of a bicycle drive unit. Since the output torque of a motor is dependent on the rotational speed of the motor, in the bicycle drive unit of Japanese Patent No. 5,575,938, the output torque of the motor changes in accordance with the rotational speed of the crankshaft. For example, if a motor that outputs a large torque at a low rotational speed is used, there are cases in which the assisting force becomes insufficient when the rotational speed of the crankshaft is increased. Further, if a motor that outputs a large torque at a high rotational speed is used, then there are cases in which the assisting force becomes insufficient when the rotational speed of the crankshaft is reduced.

One object of the present invention is to provide a bicycle drive unit that can prevent the assisting force from becoming insufficient in a cadence range that is desired by the user.

In view of the state of the known technology and in accordance with a first aspect of the present disclosure, a bicycle drive unit according to the present invention comprises a housing, an output unit, a first motor and a second motor. The housing rotatably support a crankshaft. The output unit is provided in the housing and to which rotation of the crankshaft is transmitted. The first motor is provided in the housing to assist a manual drive force without changing the ratio of the rotational speed of the output unit relative to the rotational speed of the crankshaft. The second motor is provided in the housing to assist the manual drive force without changing the ratio of the rotational speed of the output unit relative to the rotational speed of the crankshaft.

According to one example of the bicycle drive unit, the first motor and the second motor apply a drive force to the output unit.

One example of the bicycle drive unit further comprises a first speed reducer configured to decelerate a rotational speed of the first motor that is transmitted to the output unit.

One example of the bicycle drive unit further comprises a second speed reducer configured to decelerate a rotational speed of the second motor that is transmitted to the output unit.

According to one example of the bicycle drive unit, the speed reduction ratio of the first speed reducer and the speed reduction ratio of the second speed reducer are different from each other.

According to one example of the bicycle drive unit, output characteristics of the first motor and output characteristics of the second motor are different from each other.

According to one example of the bicycle drive unit, the output characteristics of the first motor and the output characteristics of the second motor are different in output torque characteristics that corresponds to the rotational speed.

One example of the bicycle drive unit further comprises a controller configured to the first motor and the second motor according to the manual drive force that is applied to the crankshaft. The controller selectively and individually operates the first motor and the second motor.

According to one example of the bicycle drive unit, the controller is configured to selectively operates the first motor and the second motor, based on at least one of the rotational speed of the crankshaft and the vehicle speed.

According to one example of the bicycle drive unit, the controller is configured to operate the first motor according to the manual drive force while the rotational speed of the crankshaft or the vehicle speed is less than a prescribed speed, and configured to operate the second motor according to the manual drive force while the rotational speed of the crankshaft or the vehicle speed is greater than or equal to the prescribed speed.

According to one example of the bicycle drive unit, the controller is configured to control an output torque of the first and second motors such that the output torque of the first motor is greater than an output torque of the second motor while a rotational speed of the first motor is less than a prescribed rotational speed and a rotational speed of the second motor is less than a prescribed rotational speed. The controller is configured to control an output torque of the first and second motors such that the output torque of the first motor is less than or equal to the output torque of the second motor while the rotational speed of the first motor is greater than or equal to the prescribed rotational speed of the first motor, the rotational speed of the second motor is greater than or equal to the prescribed rotational speed of the second motor.

According to one example of the bicycle drive unit, the housing comprises a first attaching portion to which can be attached the first motor and a second attaching portion to which can be attached the second motor. The first attaching portion is configured so that one of a plurality of first motors having different output characteristics can selectively be attached to the housing and detached from the housing.

According to one example of the bicycle drive unit, the first attaching portion is configured so that the first motor can be attached to the housing and detached from the housing.

One example of the bicycle drive unit comprises a housing that rotatably supports a crankshaft. The housing comprises a first attaching portion to which can be attached a first motor that assists a manual drive force. The first attaching portion being configured so that one of a plurality of first motors having different output characteristics can selectively be attached to the housing and detached from the housing.

According to one example of the bicycle drive unit, the first attaching portion is configured so that the first motor can be attached to the housing and detached from the housing from outside of the housing.

According to one example of the bicycle drive unit, the housing further comprises a second attaching portion to which can be attached a second motor that assists a manual drive force, the second attaching portion being configured so that one of a plurality of second motors having different output characteristics can selectively be attached to the housing and detached from the housing.

According to one example of the bicycle drive unit, the second attaching portion is configured so that the second motor can be attached to the housing and detached from the housing from outside of the housing.

One example of the bicycle drive unit further comprises an output unit to which the rotation of the crankshaft is transmitted. The first and the second motors apply a drive force to the output unit.

One example of the bicycle drive unit further comprises a third attaching portion to which can be attached a first speed reducer that decelerates the rotation of the first motor that is transmitted to the output unit, the third attaching portion being configured so that one of a plurality of first speed reducers having different speed reduction ratios can selectively be attached to the housing and detached from the housing.

One example of the bicycle drive unit further comprises a fourth attaching portion to which can be attached a second speed reducer that decelerates the rotation of the second motor and that is transmitted to the output unit. The fourth attaching portion is configured so that one of a plurality of second speed reducers having different speed reduction ratios can selectively be attached to the housing and detached from the housing.

According to one example of the bicycle drive unit, the first attaching portion comprises an opening provided in a wall of the housing and a cover body for closing the opening can be attached.

According to the bicycle drive unit, it is possible to prevent the assisting force from becoming insufficient in a cadence range that is desired by the user.

### BRIEF DESCRIPTION OF THE DRAWINGS

Referring now to the attached drawings which form a part of this original disclosure.

FIG. 1 is a side elevational view of an electrically assisted bicycle equipped with a bicycle drive unit in accordance with a first embodiment.

FIG. 2 is a side elevational view of the drivetrain of the electric bicycle illustrated FIG. 1.

FIG. 3 is a cross-sectional view of the bicycle drive unit as seen along section line 3-3 in FIG. 2.

FIG. 4 is a block diagram of the control system of die bicycle drive unit.

FIG. 5 is a graph showing the output characteristics of the first motor and the second motor.

FIG. 6 is a flowchart of a selection control that is executed by the controller.

FIG. 7 is a side elevational view of a bicycle drive unit in accordance with a second embodiment.

FIG. 8 is a partially exploded cross-sectional view of the bicycle drive unit as seen along section line 8-8 in FIG. 7.

FIG. 9 is an assembled cross-sectional view of the bicycle drive unit as seen along section line 8-8 in FIG. 7.

FIG. 10 is a graph showing the output characteristics of the first motor.

FIG. 11 is a graph showing the output characteristics of the second motor.

FIG. 12 is a cross-sectional view of the bicycle drive unit in accordance with a first modification.

FIG. 13 is a partially exploded cross-sectional view of the bicycle drive unit in accordance with a second modification.

### DETAILED DESCRIPTION OF EMBODIMENTS

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

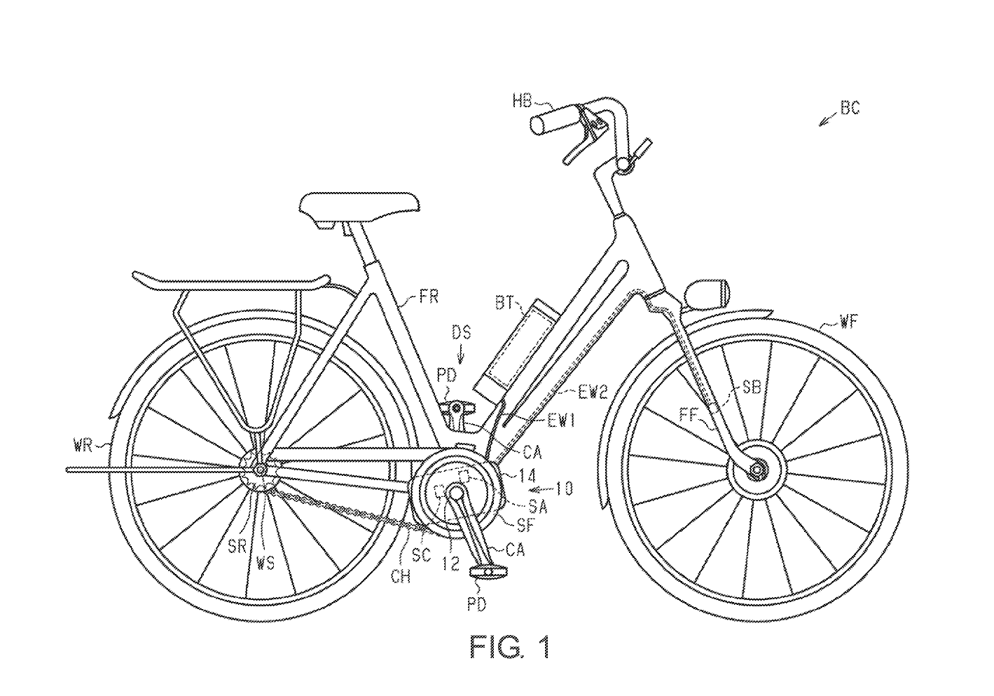

As shown in FIG. 1, an electrically assisted bicycle BC comprises a bicycle drive unit (hereinafter referred to as “drive unit 10”) in accordance with a first embodiment. In one example, the electrically assisted bicycle BC further comprises a frame FR, a front wheel WF, a rear wheel WR, and a handlebar HB. The frame FR is the main body of the electrically assisted bicycle BC. The front wheel FW and the rear wheel WR are supported on the frame FR in a rotatable state with respect to the frame FR. The handlebar HB is supported on the frame FR so as to be configured to change the orientation of the front wheel WF.

The electrically assisted bicycle BC further comprises a battery BT, a vehicle speed sensor SB, an electric wire EW1, and a pair of crank arms CA, a pair of pedals PD, a front sprocket SF, a rear sprocket SR and a chain CH, which form a drivetrain DS along with the drive unit 10. The battery BT is attached to the frame FR. The battery BT is electrically connected to the drive unit 10 by the electric wire EW1. The drive unit 10 comprises a torque sensor SA and a crank rotation sensor SC. The drive unit 10 is electrically connected to the vehicle speed sensor SB by an electric wire EW2. The crank rotation sensor SC is a cadence sensor that can detect the rotational speed of the crank.

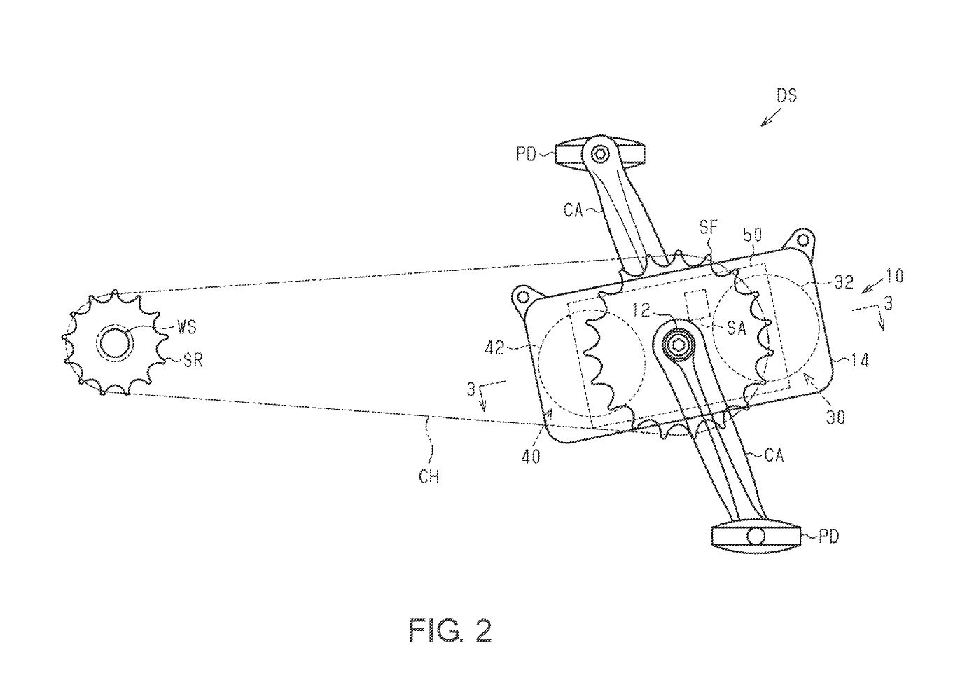

The drivetrain DS transmits a drive force from a crankshaft 12 to the rear wheel WR. The drive unit 10 is attached to the frame FR and is detachable with respect to the frame FR. An example of a means to join the drive unit 10 and the frame FR are bolts. As shown in FIG. 2, the drive unit 10 comprises a first assist unit 30, a second assist unit 40 and a control apparatus 50.

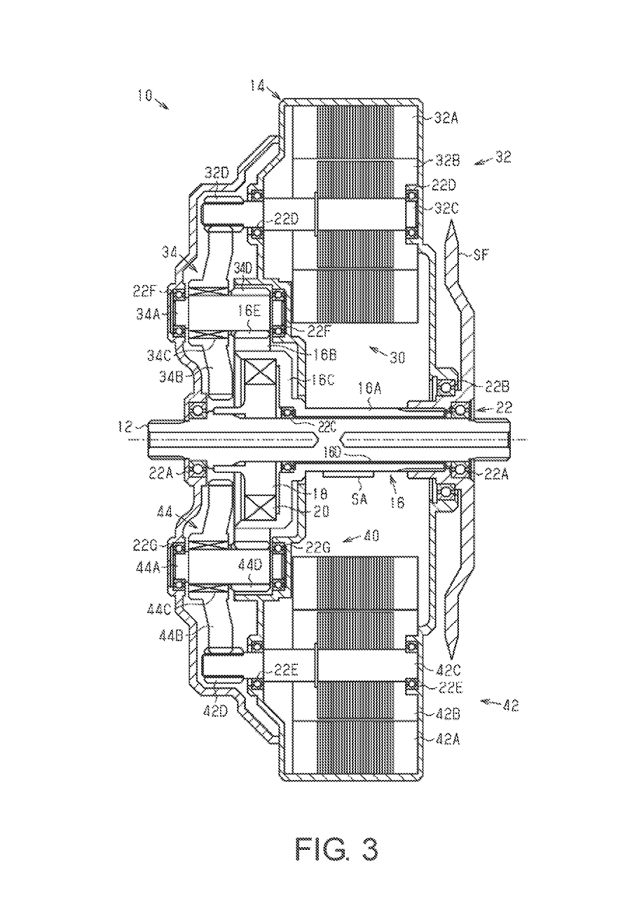

The crank arms CA are coupled to the opposite ends of the crankshaft 12 so as to be integrally rotatable with the crankshaft 12. A crank is formed by the crank arms CA and the crankshaft 12. The pedals PD are individually supported on the crank arms CA in a rotatable state with respect to the crank arms CA. The front sprocket SF is coupled to the crankshaft 22 via a one-way clutch 20 (refer to FIG. 3). The rear sprocket SR is supported by an axle WS of the rear wheel WR (refer to FIG. 1) in a rotatable state with respect to the axle WS. The rear sprocket SR is coupled to a hub of the rear wheel WR. The chain CH is engaged with the front sprocket SF and the rear sprocket SR.

When a manual drive force is inputted to the pedals PD for rotating the crank arms CA forward, the crank arms CA and the crankshaft 12 are integrally rotated in one direction around the rotational axis of the crankshaft 12. In this case, the rotation of the crankshaft 12 is transmitted to the front sprocket SF, and the rotation of the front sprocket SF is transmitted to the rear sprocket SR and the rear wheel WR by the chain CH. When a manual drive force is input to the pedals PD for rotating the crank arms CA rearward, the crank arms CA and the crankshaft 12 are integrally rotated in the other direction around the rotational axis of the crankshaft 12. In this case, the rotation of the crankshaft 12 is not transmitted to the front sprocket SF through the action of the one-way clutch 20. The one-way clutch 20 can be omitted.

As shown in FIG. 1, the torque sensor SA is provided in the drive unit 10 and outputs a signal that reflects a manual drive force that is input by the crankshaft 12. The torque sensor SA is, for example, a strain gauge, a semiconductor strain sensor, or a magnetostrictive sensor. The torque sensor SA is attached in a power transmission path from, for example, the crankshaft 12 to the front sprocket SF. The torque sensor SA is preferably provided in the power transmission path from the one-way clutch 20 to the front sprocket SF. When configuring the torque sensor SA by a magnetostrictive sensor, a magnetostrictive element is provided in the power transmission path from the crankshaft 12 to the front sprocket SF, and this magnetostrictive element is detected by the magnetostrictive sensor.

The vehicle speed sensor SB is, for example, a magnetic sensor. The vehicle speed sensor SB is provided on, for example, a front fork FF of the frame FR. The vehicle speed sensor SB responds to a magnet that is provided on the front wheel WF and outputs a signal reflecting the rotational speed of the front wheel WF. The vehicle speed sensor SB can be provided, for example, on a chain stay of the frame FR, in this case, the vehicle speed sensor responds to a magnet that is provided on the rear wheel WR and outputs a signal reflecting the rotational speed of the rear wheel WR.

The signals of the torque sensor SA and the crank rotation sensor SC are transmitted to the control apparatus 50 (refer to FIG. 2) via an electric wire (not shown) in the drive unit 10. The signal of the vehicle speed sensor SB is transmitted to the control apparatus 50 via the electric wire EW2. In another example, at least one of the torque sensor SA, the vehicle speed sensor SB, and the crank rotation sensor SC can be configured to wireless communicate with the control apparatus 50.

As shown in FIG. 2, the first assist unit 30 and the second assist unit 40 are provided in the housing 14 of the drive unit 10. The first assist unit 30 comprises a first motor 32. The first motor 32 is provided in the housing 14. The first motor 32 is configured to assist the manual drive force without changing the ratio of the rotational speed of the output unit 16 (refer to FIG. 3) relative to the rotational speed of the crankshaft 12. The second assist unit 40 comprises a second motor 42. The second motor 42 is provided in the housing 14. The second motor 42 is configured to assist the manual drive force without changing the ratio of the rotational speed of the output unit 16 relative to the rotational speed of the crankshaft 12. The first motor 32 and the second motor 42 are, for example, electric motors. The outputs of the first motor 32 and the second motor 42 are transmitted via the power transmission path from the crankshaft 12 to the front sprocket SF. The first motor 32 and the second motor 42 are configured to assist the manual drive force according to the detection result of the torque sensor SA.

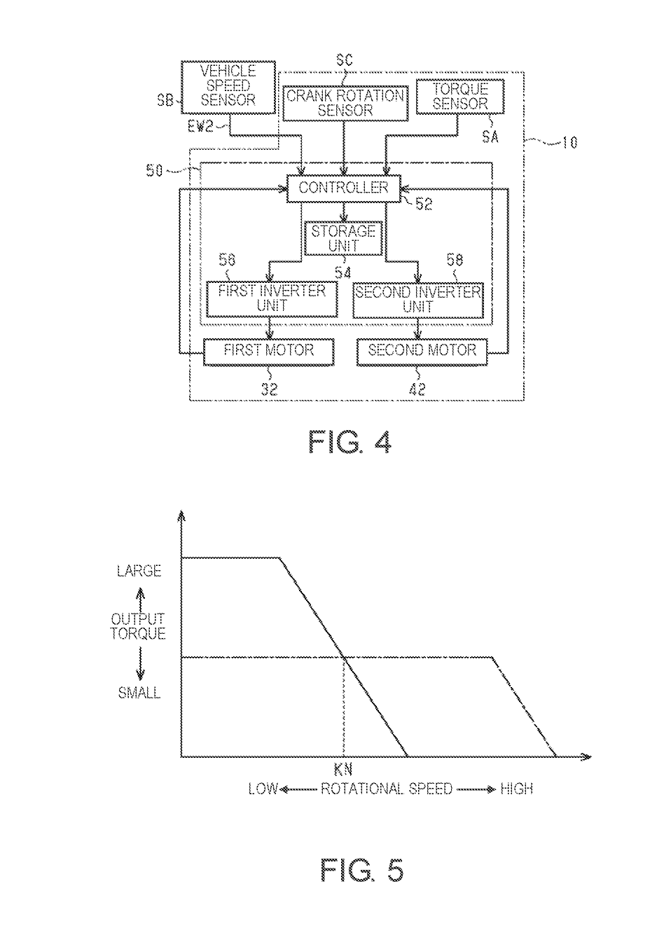

As shown in FIG. 4, the control apparatus 50 is provided in the drive unit 10. The control apparatus 50 comprises a controller 52. In one example, the control apparatus 50 further comprises a storage unit 54, a first inverter unit 56 and a second inverter unit 58. The controller 52 comprises a calculation processing device for executing a control program that is set in advance. The calculation processing device comprises, for example, a CPU (Central Processing Unit) or an MPU (Micro Processing Unit).

The storage unit 54 comprises a nonvolatile memory. The storage unit 54 stores information used for controlling the controller 52. The information stored in the storage unit 54 includes a control program that is set in advance, which is executed by the calculation processing device of the controller 52. The first inverter unit 56 comprises a switching circuit that converts DC power of the battery BT (refer to FIG. 1) to three-phase AC power by a switching control and controls the supply of the three-phase AC power to the first motor 32, based on a command signal of the controller 52. The second inverter unit 58 comprises a switching circuit that generates a three-phase AC power and controls the supply of the three-phase AC power to the second motor 42, in the same manner as the first inverter unit 56.

As shown in FIG. 3, the drive unit 10 further comprises a housing 14, an output unit 16, a holding part 18 and a one-way clutch 20. The housing 14 rotatably supports the crankshaft 12. The output unit 16 is provided in the housing 14 and the rotation of the crankshaft 12 is transmitted thereto.

The first assist unit 30 preferably further comprises a first speed reducer 34. The second assist unit 40 preferably further comprises a second speed reducer 44. The first speed reducer 34 decelerates the rotation of the first motor 32 and transmits the rotation of the first motor 32 to the output unit 16. The second speed reducer 44 decelerates the rotation of the second motor 42 and transmits the rotation of the second motor 42 to the output unit 16. In the present embodiment, the speed reduction ratio of the first speed reducer 34 and the speed reduction ratio of the second speed reducer 44 are equal to each other. In another example, the speed reduction ratio of the first speed reducer 34 and the speed reduction ratio of the second speed reducer 44 are different from each other. In this case, the drive unit 10 can comprise the first motor 32 and the second motor 42 that have the same output characteristics.

The drive unit 10 further comprises a plurality of axle bearings 22. The axle bearings 22 include a first axle bearing 22A, a second axle bearing 22B, a third axle bearing 22C, a fourth axle bearing 22D, a fifth axle bearing 22E, a sixth axle bearing 22F, and a seventh axle bearing 22G.

The housing 14 houses the crankshaft 12, the output unit 16, the first motor 32, the first speed reducer 34, the second motor 42, the second speed reducer 44, the plurality of axle bearings 22, and the control apparatus 50 (not shown in FIG. 3, refer to FIG. 4). In another example, the control apparatus 50 can be provided on the outside of the housing 14, and at least a portion of the first motor 32 and the second motor 42 can be provided on the outside of the housing 14. The two ends of the crankshaft 12 protrude from the housing 14. The front sprocket SF is arranged on the side of the housing 14.

The first axle bearing 22A comprises a pair of bearings. One bearing of the first axle bearing 22A is attached between the housing 14 and one end of the crankshaft 12. The other bearing of the first axle bearing 22A is attached between the inner perimeter surface of the front sprocket SF and the other end of the crankshaft 12. The second axle bearing 22B comprises a bearing, which is attached between the housing 14 and an outer perimeter surface of the front sprocket SF. By the first axle bearing 22A and the second axle bearing 22B, the crankshaft 12 is rotatable relative to the housing 14 and the front sprocket SF, and the front sprocket SF is rotatable relative to the crankshaft 12 and the housing 14. A magnet (not shown) is provided on the outer perimeter surface of the crankshaft 12. This magnet is provided on the opposite side of the front sprocket SF with respect to the torque sensor SA in the axial direction of the crankshaft 12. The crank rotation sensor SC (refer to FIG. 2) is provided on the opposite side of the front sprocket SF with respect to the torque sensor SA in the axial direction of the crankshaft 12, and comprises a magnetic sensor that can detect the magnet. The crank rotation sensor SC is provided in the housing 14 and detects a magnet that is provided on the crankshaft 12.

The output unit 16 comprises a first cylindrical portion 16A, a second cylindrical portion 16B and a connecting portion 16C. The first cylindrical portion 16A and the second cylindrical portion 16B comprise a hole 16D into which the crankshaft 12 is inserted. The inner diameter and the outer diameter of the second cylindrical portion 16B are larger than the inner diameter and the outer diameter of the first cylindrical portion 16A. The connecting portion 16C connects the first cylindrical portion 16A and the second cylindrical portion 16B. The output unit 16 transmits a torque to the front sprocket SF that is obtained by combining the torque of the crankshaft 12, and the torque of the first motor 32 or the second motor 42.

The first cylindrical portion 16A is, for example, spline fitted with the front sprocket SF. The torque sensor SA is attached to the outer perimeter portion of the first cylindrical portion 16A. The torque sensor SA outputs a signal corresponding to the torque that is applied to the first cylindrical portion 16A. The second cylindrical portion 16B is coupled with each of the first speed reducer 34 and the second speed reducer 44. The second cylindrical portion 16B is provided with a portion that is farther from the front sprocket SF than the first cylindrical portion 16A. A gear 16E is provided on the outer perimeter portion of the second cylindrical portion 16B. The gear 16E can be integrally formed with the output unit 16, or can be formed as a separate body from the output unit 16 and non-rotatably fixed to the output unit 16. The inner perimeter portion of the connecting portion 16C is attached a third axle bearing 22C, which is attached to the crankshaft 12. The third axle bearing 22C comprises a bearing. The output unit 16 is supported so as to be rotatable with respect to the crankshaft 12. In another example of the output unit 16, the gear 16E can be provided between the torque sensor SA and the portion of the output unit 16 to which the front sprocket SF is attached.

The holding part 18 is attached on the inner side of the second cylindrical portion 16B in the radial direction of the crankshaft 12 at an interval from the second cylindrical portion 16B. The one-way clutch 20 is attached to each of the second cylindrical portion 16B and the holding part 18 in a state of being sandwiched between the inner perimeter part of the second cylindrical portion 16B and the holding part 18. The one-way clutch 20 is configured to transmit the rotation of the crankshaft 12 to the output unit 16, and to not transmit the rotation of the output unit 16 to the crankshaft 12. In one example, the one-way clutch 20 comprises at least one pawl and a ratchet. The one-way clutch 20 can be formed as a roller clutch as well.

The first motor 32 and the second motor 42 apply a drive force to the output unit 16. The first motor 32 and the second motor 42 are arranged in positions away from each other in the periphery of the crankshaft 12. As shown in FIGS. 2 and 3, the first motor 32 and the second motor 42 are arranged on the opposite sides of each other with respect to the crankshaft 12. In another example, both the first motor 32 and the second motor 42 can be arranged on one side with respect to a plane that passes through the crankshaft 12. The type of the first motor 32 and the second motor 42 is an inner rotor type. In another example, the type of the first motor 32 and the second motor 42 can be an outer rotor type as well.

The attachment structure of the first motor 32 with respect to the housing 14 can take any of a plurality of configurations. In a first embodiment, the first motor 32 can be fixed to the housing 14. In a second embodiment, the first motor 32 can be detachable with respect to the housing 14.

The first motor 32 comprises a first stator 32A, a first rotor 32B and a first output shaft 32C. A fourth axle bearing 22D comprises a pair of bearings. One bearing of the fourth axle bearing 22D supports one end of the first output shaft 32C. The other bearing of the fourth axle bearing 22D supports the other end of the first output shaft 32C. The first rotor 32B is fixed to the first output shaft 32C. The first rotor 32B and the first output shaft 32C are rotatable relative to the housing 14. The rotational axis of the first output shaft 32C′ is parallel to the rotational axis of the crankshaft 12.

The attachment structure of the second motor 42 with respect to the housing 14 can take any of a plurality of configurations. In a first embodiment, the second motor 42 can be fixed to the housing 14. In a second embodiment, the second motor 42 can be detachable with respect to the housing 14.

The second motor 42 comprises a second stator 42A, a second rotor 42B, and a second output shaft 42C. A fifth axle bearing 22E comprises a pair of bearings. One bearing of the fifth axle bearing 22E supports one end of the second output shaft 42C. The other bearing of the fifth axle bearing 22E supports the other end of the second output shaft 42C. The second rotor 42B is fixed to the second output shaft 42C. The second rotor 42B and the second output shaft 42C are rotatable relative to the housing 14. The rotational axis of the second output shaft 42C is parallel to the rotational axis of the crankshaft 12.

The first speed reducer 34 comprises a first gear 32D, a rotational shaft 34A, a second gear 34B, a one-way clutch 34C, a third gear 34D and the gear 16E. The total number and the total number of teeth of the gears of the first speed reducer 34 can be freely changed, as long as the rotational speed of the front sprocket SF becomes lower than the rotational speed of the first motor 32 and the front sprocket SF can be rolled forward, when the first motor 32 is driven. In a first example, the first speed reducer 34 can carry out deceleration in several ways. First, the first speed reducer 34 can carry out deceleration by only the first gear 32D and the second gear 34B. Second, the first speed reducer 34 can carry out deceleration by only the second gear 34B and the third gear 34D. Third, the first speed reducer 34 can carry out deceleration by only the third gear 34D and the gear 16E. In a second example, the first speed reducer 34 can further comprise at least one gear in addition to the first gear 32D, the second gear 34B, the third gear 34D and the gear 16E. The first gear 32D can take any of a plurality of configurations. In a first embodiment, the first gear 32D is a part that is configured separately from the first output shaft 32C, and can be fixed to the first output shaft 32C. In a second embodiment, the first gear 32D can be formed by processing a portion of the first output shaft 32C.

The second gear 34B is supported on the rotational shaft 34A via the one-way clutch 34C. The second gear 34B is engaged with the first gear 32D. The total number of teeth on the first gear 32D is less than the total number of teeth on the second gear 34B.

The one-way clutch 34C transmits the rotation of the second gear 34B to the rotational shaft 34A in a first rotational direction, but does not transmit rotation between the rotational shaft 34A and the second gear 34B in a second rotational direction. The second rotational direction is a rotational direction that is opposite of the first rotational direction.

The third gear 34D is provided on the outer perimeter surface of the rotational shaft 34A. The third gear 34D is provided closer to the first motor 32 than the second gear 34B with respect to a direction along the rotational axis of the rotational shaft 34A. The third gear 34D is engaged with the gear 16E, which is provided on the output unit 16. The total number of teeth of the third gear 34D is less than the total number of teeth of the second gear 34B and the total number of teeth of the gear 16E. The third gear 34D can take a plurality of configurations. In a first embodiment, the third gear 34D can be configured separately from the rotational shaft 34A and can be fixed to the rotational shaft 34A. In a second embodiment, the third gear 34D can be formed by processing a portion of the rotational shaft 34A.

The sixth axle bearing 22F comprises a pair of bearings. One bearing of the sixth axle bearing 22F is attached between the housing 14 and the outer perimeter surface of one end of the rotational shaft 34A. The other bearing of the sixth axle bearing 22F is attached between the housing 14 and the outer perimeter surface of the other end of the rotational shaft 34A. Accordingly, the rotational shaft 34A is rotatable with respect to the housing 14. The second gear 34B and the third gear 34D are provided between one bearing of the sixth axle bearing 22F and the other bearing of the sixth axle bearing 22F.

The second speed reducer 44 comprises a fifth gear 42D, a rotational shaft 44A, a sixth gear 44B, a one-way clutch 44C, a seventh gear 44D and the gear 16E. The total number and the total number of teeth of the gears of the second speed reducer 44 can be freely changed as long as the rotational speed of the front sprocket SF becomes lower than the rotational speed of the second motor 42 and the front sprocket SF can be rolled forward when the second motor 42 is driven. In a first example, the second speed reducer 44 can carry out deceleration in several ways. First, the second speed reducer 44 can carry out deceleration by only the fifth gear 42D and the sixth gear 44B. Second, the second speed reducer 44 can carry out deceleration by only the sixth gear 44B and the seventh gear 44D. Third, the second speed reducer 44 can carry out deceleration by only the seventh gear 44D and the gear 16E. In a second example, the second speed reducer 44 can further comprise at least one gear in addition to the fifth gear 42D, the sixth gear 44B, the seventh gear 44D and the gear 16E. The fifth gear 42D can take a plurality of configurations. In a first embodiment, the fifth gear 42D is a part that is configured separately from the second output shaft 42C, and can be fixed to the second output shaft 42C. In a second embodiment, the fifth gear 42D can be formed by processing a portion of the second output shaft 42C.

The sixth gear 44B is attached on the outer perimeter surface of the one-way clutch 44C. The sixth gear 44B is engaged with the fifth gear 42D of the second motor 42. The total number of teeth of the sixth gear 44B is greater than the total number of teeth of the fifth gear 42D.

The one-way clutch 44C transmits the rotation of the sixth gear 44B in a first rotational direction to the rotational shaft 44A, and does not transmit the rotation between the rotational shaft 44A and the sixth gear 44B in a second rotational. The second rotational direction is a rotational direction that is opposite of the first rotational direction.

The seventh gear 44D is provided on the outer perimeter surface of the rotational shaft 44A. The seventh gear 44D is provided closer to the second motor 42 than the sixth gear 44B, in a direction along the rotational axis of the rotational shaft 44A. The seventh gear 44D is engaged with the gear 16E of the output unit 16. The total number of teeth of the seventh gear 44D is less than the total number of teeth of the sixth gear 44B and the total number of teeth of the gear 16E. The seventh gear 44D can take a plurality of configurations. In a first embodiment, the seventh gear 44D can be configured separately from the rotational shaft 44A and can be fixed to the rotational shaft 44A. In a second embodiment, the seventh gear 44D can be formed by processing a portion of the rotational shaft 44A.

The seventh axle bearing 22G comprises a pair of bearings. One bearing of the seventh axle bearing 22G is attached between the housing 14 and the outer perimeter surface of one end of the rotational shaft 44A. The other bearing of the seventh axle bearing 22G is attached between the housing 14 and the outer perimeter surface of the other end of the rotational shaft 44A. Accordingly, the rotational shaft 44A is rotatable with respect to the housing 14. The sixth gear 44B and the seventh gear 44D are provided between one bearing of the seventh axle bearing 22G and the other bearing of the seventh axle bearing 22G.

As shown in FIG. 4, the controller 52 receives a signal of the torque sensor SA and a signal of the vehicle speed sensor SB. The controller 52 calculates the assisting force and the vehicle speed based on the signal received from the torque sensor SA and the signal received from the vehicle speed sensor SB. The controller 52 is programmed to control the first inverter unit 56 and the second inverter unit 58 based on the calculated assisting force, the vehicle speed, and the rotational speed of the crankshaft 12. That is, the controller 52 controls the first motor 32 and the second motor 42 according to the manual drive force that is applied to the crankshaft 12. The controller 52 selectively operates the first motor 32 and the second motor 42. Specifically, the controller 52 is programmed to selectively operate the first motor 32 and the second motor 42 based on at least one of the vehicle speed and the rotational speed of the crankshaft 12. The controller 52 can selectively cause the first motor 32 and the second motor 42 to operate according to the rotational speeds of the first motor 32 and the second motor 42 instead of the vehicle speed and the rotational speed of the crankshaft 12 as well. In this case, the controller 52 is configured to receive a signal from a rotational speed sensor of the motor output shaft provided to the first motor 32 and the second motor 42.

FIG. 5 shows the output characteristics of the first motor 32 and the output characteristics of the second motor 42. The output characteristics is the relationship between the rotational speed of the motor and the output torque of the motor. The output torque is the rated torque of the motor. The solid line graph in FIG. 5 shows the output characteristics of the first motor 32, and the dashed line graph shows the output characteristics of the second motor 42.

The output characteristics of the first motor 32 and the output characteristics of the second motor 42 are different from each other. When the rotational speed of the first motor 32 and the rotational speed of the second motor 42 are a prescribed rotational speed KN, the output torque of the first motor 32 and the output torque of the second motor 42 are equal. The output torque of the first motor 32, when the rotational speed of the first motor 32 is less than the prescribed rotational speed KN, is greater than the output torque of the second motor 42 when the rotational speed of the second motor 42 is less than the prescribed rotational speed KN. The output torque of the first motor 32, when the rotational speed of the first motor 32 is greater than or equal to the prescribed rotational speed KN, is smaller than the output torque of the second motor 42 when the rotational speed of the second motor 42 is greater than or equal to the prescribed rotational speed KN. In this manner, the output characteristics of the first motor 32 and the output characteristics of the second motor 42 are different in the characteristics of the output torque that corresponds to the rotational speed.

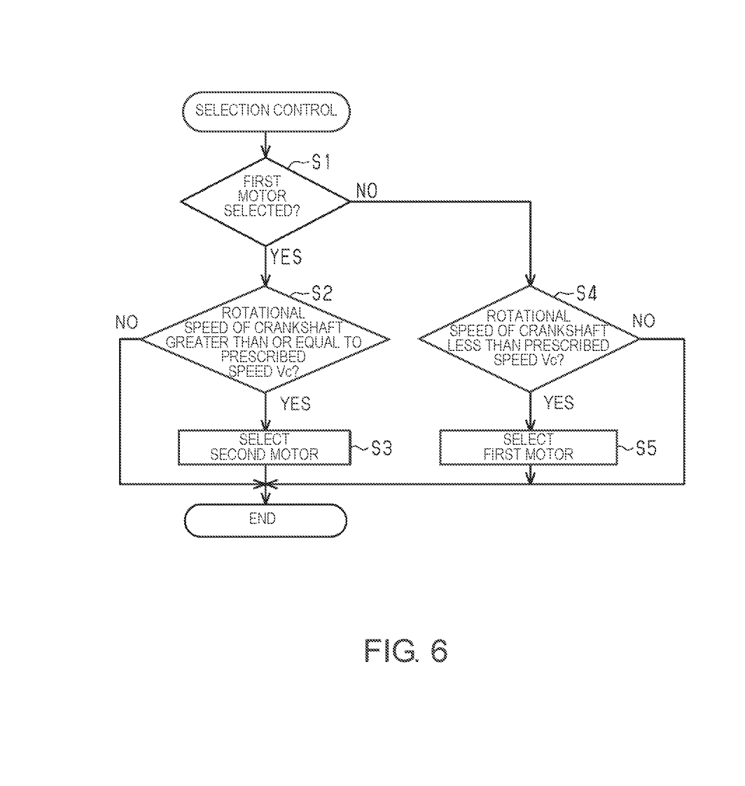

The controller 52 (refer to FIG. 4) executes a selection control for selecting the motor to be driven from the first motor 32 and the second motor 42 (refer to FIG. 4 for both) based on the rotational speed of the crankshaft 12. The controller 52 executes the selection control for each prescribed control cycle. FIG. 6 is one example of a flowchart of the selection control. The rotational speed of the crankshaft 12 is proportional to the rotational speed of the motor. When the torque sensor SA is not detecting a manual drive force of greater than or equal to a prescribed value, the controller 52 does not drive the first motor 32 or the second motor 42. In addition, when the vehicle speed sensor SB is detecting a speed of greater than or equal to a prescribed speed Vmax, the controller 52 does not drive the first motor 32 or the second motor 42. The prescribed speed Vmax is, for example, 25 km per hour. The controller 52 controls the motor, which is selected based on the selection control flowchart of FIG. 6, based on the manual drive force and the vehicle speed.

In Step S1, the controller 52 determines whether or not the first motor 32 is selected as the motor to be driven. If the determination result of Step S1 is affirmative, then Step S2 is executed. If the determination result of Step S1 is negative, then Step S4 is executed.

In Step S2, the controller 52 determines whether or not the rotational speed of the crankshaft 12 is greater than or equal to a prescribed speed Vc. The controller 52 calculates the rotational speed of the crankshaft 12 based on the detection result of the crank rotation sensor SC. The prescribed speed Vc is set in advance based on the prescribed rotational speed KN. The prescribed speed Vc can be freely set, but it is preferable for the rotational speed of the motor to become the prescribed rotational speed KN or a speed that is close to the prescribed rotational speed KN, when the rotational speed of the crankshaft 12 is the prescribed speed Vc. Information regarding the prescribed speed Vc is stored in the storage unit 54. For example, an external computer can be connected to the controller 52 by wire or by wireless, and information regarding the prescribed speed Vc stored in the storage unit 54 can be changed by the external computer. If the determination result of Step S2 is affirmative, Step S3 is executed. If the determination result of Step S2 is negative, the selection control is temporarily ended.

In Step S3, the controller 52 selects the second motor 42 as the control target, and switches the motor to be driven from the first motor 32 to the second motor 42. That is, when the rotational speed of the crankshaft 12 is greater than or equal to the prescribed speed Vc, the controller 52 operates the second motor 42 according to the manual drive force.

In Step S4, the controller 52 determines whether or not the rotational speed of the crankshaft 12 is less than the prescribed speed Vc. If the determination result of Step S4 is affirmative, then Step S5 is executed. If the determination result of Step S4 is negative, then the selection control is temporarily ended.

In Step S5, the controller 52 selects the first motor 32 as the control target, and switches the motor to be driven from the second motor 42 to the first motor 32. That is, when the rotational speed of the crankshaft 12 is less than the prescribed speed Vc, the controller 52 operates the first motor 32 according to the manual drive force.

Parameters used to select the motor to be driven can be freely changed. In one example, the controller 52 can use the vehicle speed instead of the rotational speed of the crankshaft 12. In this case, the controller 52 operates the first motor 32 according to the manual drive force when the vehicle speed is less than the prescribed speed Vb, and operates the second motor 42 according to the manual drive force when the vehicle speed is greater than or equal to the prescribed speed Vb. The prescribed speed Vb can be freely set in a range less than a prescribed speed Vmax. It is preferable for the prescribed speed Vb to be set so that the rotational speed of the first motor 32 and the rotational speed of the second motor 42 become the prescribed rotational speed KN or a speed that is close to the prescribed rotational speed KN, when the crankshaft 12 is being rotated so as to be the prescribed speed Vb. If a transmission is not provided on the bicycle, then the gear ratio becomes constant. Therefore, when the rotation of the crankshaft 12 is being transmitted to the rear wheel, the vehicle speed is proportional to the rotational speed of the motor. Even if a transmission is provided on the bicycle, the relationship between the rotational frequency of the crankshaft 12 and the vehicle speed can be calculated by determining the gear ratio, by detecting the gear shift stage with a sensor. The controller 52 can select the motor based on the rotation of the crankshaft 12 when the crankshaft 12 is being rotated, and select the motor based on the vehicle speed when the rotation of the crankshaft 12 is stopped. The controller 52 can also select the motor to be driven using the rotational speed of the crank arm CA, the rotational speed of a member that is rotated due to the rotation of the crankshaft 12, or the rotational speeds of the first motor 32 and the second motor 42, instead of the rotational speed of the crankshaft 12.

According to the first embodiment, the following actions and effects are obtained.

(1) The drive unit 10 comprises the first motor 32 and the second motor 42. By the output characteristics of the first motor 32 and the output characteristics of the second motor 42 being different, it is possible to prevent the assisting force from becoming insufficient in a cadence range that is desired by the user.

(2) The controller 52 drives the first motor 32 and the second motor 42 based on at least one of the vehicle speed and the rotational speed of the crankshaft 12. Accordingly, it is possible to select a motor with the appropriate output characteristics according to the running state.

### Second Embodiment

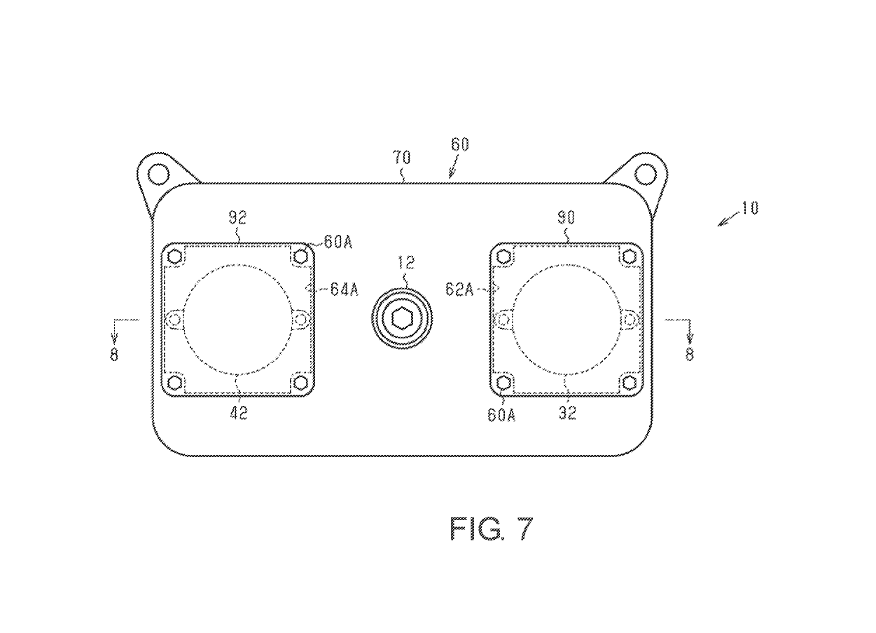

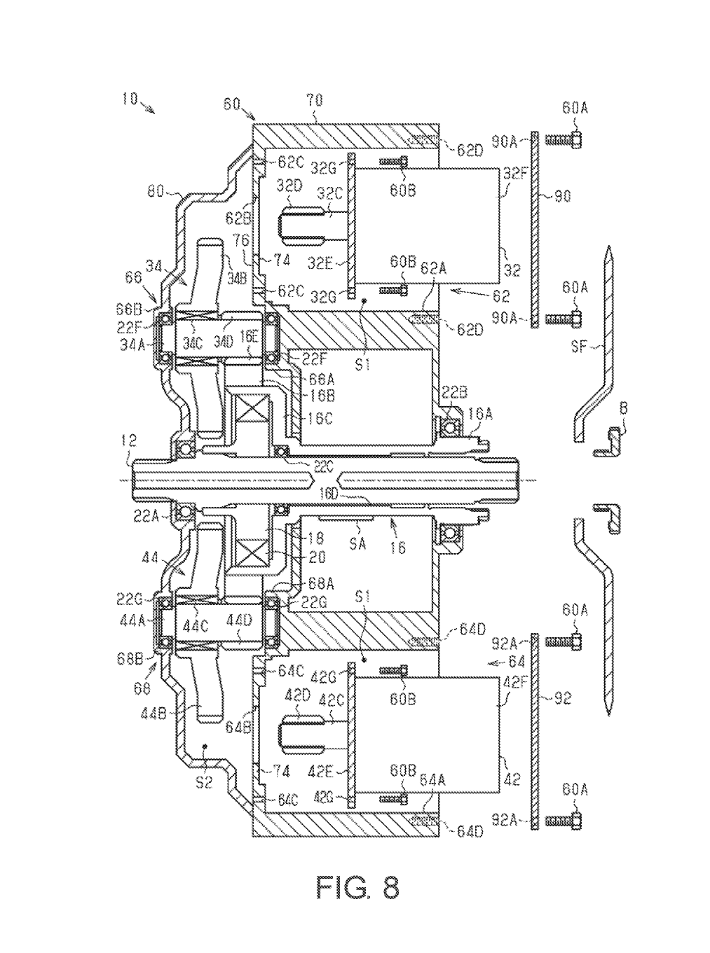

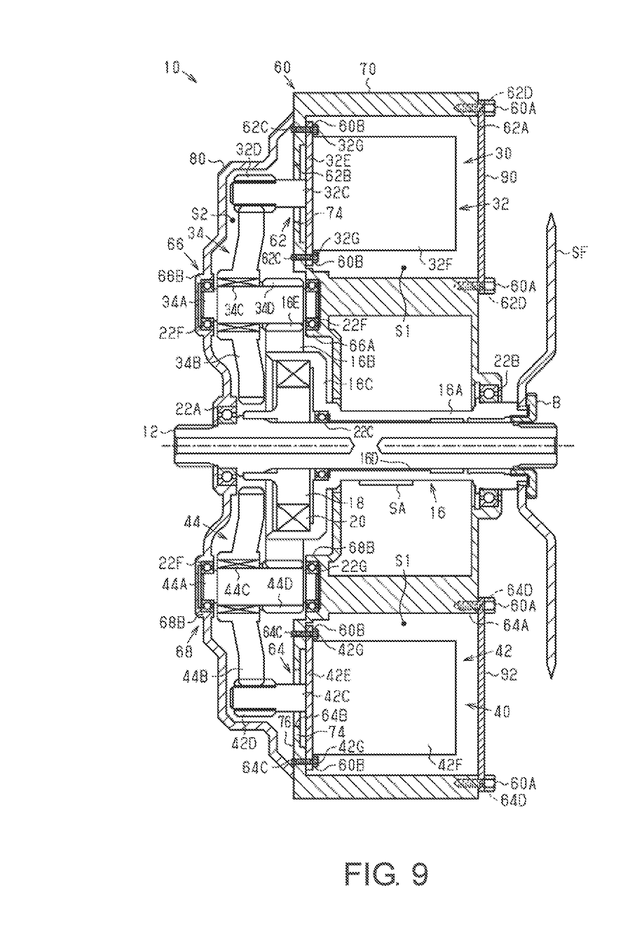

Referring to FIGS. 7 to 11, the drive unit 10 is illustrated in accordance with a second embodiment. The configuration of the drive unit 10 of the second embodiment differs from the configuration of the drive unit 10 of the first embodiment mainly in the points described below. FIGS. 8 and 9 show a cross section along the 8-8 line in FIG. 7.

As shown in FIGS. 7 and 8, the drive unit 10 comprises an output unit 16 to which the rotation of the crankshaft 12 is transmitted, in the same manner as the drive unit 10 of the first embodiment. The first motor 32 and the second motor 42 apply a drive force to the output unit 16. A housing 60 of the drive unit 10 comprises a first housing 70, a second housing 80 (refer to FIG. 8), a first cover body 90, and a second cover body 92. The housing 60 rotatably supports the crankshaft 12, in the same manner as the housing 14 of the first embodiment.

As shown in FIG. 8, the housing 60 comprises a first attaching portion 62 to which can be attached the first motor 32. The housing 60 preferably comprises a second attaching portion 64 to which can be attached the second motor 42. The first attaching portion 62 and the second attaching portion 64 are formed in the first housing 70. The first attaching portion 62 has a first opening 62A that is provided in the wall of the housing 60. The second attaching portion 64 has a second opening 64A that is provided in the wall of the housing 60.

The first cover body 90 is detachably attached to the housing 60 and closes the first opening 62A. The second cover body 92 is detachably provided to the housing 60 and closes the second opening 64A. The first and second openings 62A, 64A are provided in the housing 60 in a direction along the rotational axis of the crankshaft 12. In the present embodiment, the first and second openings 62A and 64A are provided in the wall of the housing 60 on the side with the front sprocket SF.

As shown in FIG. 8 or FIG. 9, the first housing 70 and the second housing 80 are individually configured as separate parts. The first housing 70 and the second housing 80 are fixed to each other by bolts or the like. The first housing 70 comprises a first attaching portion 62 and a second attaching portion 64. The first attaching portion 62 and the second attaching portion 64 each form a first housing space S1.

The first motor 32 comprises a bracket 32E and a motor housing 32F. A rotor and a stator (not shown) are housed in the motor housing 32F. The first output shaft 32C protrudes from the motor housing 32F. A through-hole 32G is formed in the bracket 32E, in a portion that protrudes further outside than the motor housing 32F, in the radial direction of the first motor 32. A bolt 60B for attaching the first motor 32 to the first attaching portion 62 is inserted in the through-hole 32G. The structure for attaching the first motor 32 to the first attaching portion 62 can be freely changed. The bracket 32E can be omitted from the first motor 32, and the motor housing 32F of the first motor 32 can be attached to the first attaching portion 62 by a bolt. On the housing 60, a second housing 80 is detachably fixed on the opposite side from the front sprocket SF in a direction along the rotational axis of the crankshaft 12. The second housing 80 forms a second housing space S2 along with the end 76 of the first housing 70. The first speed reducer 34 and the second speed reducer 44 are arranged in the second housing space S2.

The first attaching portion 62 comprises a support portion 74 for supporting the first motor 32. The support portion 74 is formed on the end 76 of the first housing 70. A first hole 62B, through which the first output shaft 32C of the first motor 32 passes, is formed in the support portion 74. The support portion 74 has a plurality of second holes 62C for fixing the bracket 32E. The second holes 62C are provided adjacent to the periphery of the first hole 62B.

The first cover body 90 is configured to close the first opening 62A. The first cover 90 can be attached to the first attaching portion 62. The first housing 70 has one or more holes 62D that are formed adjacent to the periphery of the first opening 62A in the first housing 70. A female thread is formed in each of the holes 62D. The first cover body 90 comprises a plurality of holes 90A. The first cover body 90 is fixed to the housing 60 so as to close the first opening 62A by bolts 60A inserted in the holes 90A and screwed into the female threads of the holes 62D. The structure for attaching the first cover body 90 to the housing 60 can be freely changed. The drive unit 10 can comprise a structure for fitting a recess, or a protrusion provided on the first cover body 90 and a protrusion or a recess provided on the housing 60.

The second attaching portion 64 comprises the support portion 74 for supporting the second motor 42. The support portion 74 is formed on the end 76 of the first housing 70. A second hole 64B is formed in the support portion 74. The second output shaft 42C of the second motor 42 passes through the second hole 64B in the support portion 74. The support portion 74 further has a plurality of second holes 64C for fixing the bracket 42E of the second motor 42. The second holes 64C are provided adjacent to the periphery of the second hole 64B.

The second cover body 92 is configured to close the second opening 64A. The second cover body 92 can be attached to the second attaching portion 64. One or a plurality of holes 64D are formed adjacent to the periphery of the second opening 64A in the first housing 70. A female thread is formed in each of the holes 64D. The second cover body 92 comprises a plurality of holes 92A. The second cover body 92 is fixed to the housing 60 so as to close the second opening 64A by the bolts 60A that are inserted in the holes 92A and screwed into the female threads of the holes 64D. The structure for attaching the second cover body 92 to the housing 60 can be freely changed, as the structure for attaching the first cover body 90 to the housing 60, as, for example, the first example and the second example of the first cover body 90 described above.

The first attaching portion 62 is configured so that the first motor 32 can be attached to and detached from the housing 60 from the outside of the housing 60. The first attaching portion 62 is configured so that one of the plurality of the first motors 32 having different output characteristics can be selectively attached to and detached therefrom. As shown in FIG. 9, the first motor 32 is attached to a support portion 74 that configures the first attaching portion 62 in a state in which the first output shaft 32C is inserted in the first hole 62B. The first motor 32 is detachably attached to the first attaching portion 62 by bolts 60B which are inserted in the through-holes 32G of the bracket 32E and coupled to the second holes 62C of the first attaching portion 62.

The second attaching portion 64 is configured so that the second motor 42 can be attached to and detached from the housing 60 from the outside of the housing 60. The second attaching portion 64 is configured so that one of the plurality of the second motors 42 having different output characteristics can be selectively attached thereto/detached therefrom. The second motor 42 comprises a bracket 42E and a motor housing 42F. The bracket 42E and the motor housing 42F are the same as the bracket 32E and the motor housing 32F of the first motor 32. The bracket 42E of the second motor 42 comprises through-holes 42G, as in the bracket 32E of the first motor 32. As shown in FIG. 9, the attachment structure of the second motor 42 to the second attaching portion 64 is the same as the attachment structure of the first motor 32 to the first attaching portion 62. The structure for attaching the second motor 42 to the second attaching portion 64 can also be freely changed, in the same manner as the structure for attaching the first motor 32 to the first attaching portion 62.

The combination of the attachment structure of the first motor 32 and the first attaching portion 62, and the attachment structure of the second motor 42 and the second attaching portion 64 can be freely changed. Of the plurality of motors, at least one motor can be configured to be detachable with respect to the housing 60, and at least one motor can be configured to be non-detachable with respect to the housing 60. In a first example, the drive unit 10 can be configured so that the first motor 32 is detachable with respect to the first attaching portion 62, and so that the second motor 42 is non-detachable with respect to the second attaching portion 64. In a second example, the drive unit 10 can be configured so that the first motor 32 is non-detachable with respect to the first attaching portion 62, and so that the second motor 42 is detachable with respect to the second attaching portion 64.

The housing 60 preferably further comprises a third attaching portion 66 and a fourth attaching portion 68. The third attaching portion 66 attaches the first speed reducer 34. The fourth attaching portion 68 attaches the second speed reducer 44. The third attaching portion 66 comprises a first holding portion 66A and a second holding portion 66B. The first holding portion 66A is formed in the first housing 70. The second holding portion 66B is formed in the second housing 80. The first holding portion 66A holds the sixth axle bearing 22F on the side with the third gear 34D. The second holding portion 66B holds the sixth axle bearing 22F on the side with the second gear 34B. Accordingly, the third attaching portion 66 holds the first speed reducer 34 so as to be rotatable with respect to the housing 60. The fourth attaching portion 68 comprises a first holding portion 68A and a second holding portion 68B, in the same manner as the third attaching portion 66. The supporting structure of the second speed reducer 44 by the fourth attaching portion 68 is the same as the supporting structure of the first speed reducer 34 by the third attaching portion 66.

The front sprocket SF is configured so as to be detachable with respect to the output unit 16. The front sprocket SF is spline fitted to the distal end portion of the first cylindrical portion 16A in the output unit 16, in a direction along the rotational axis of the crankshaft 12, and is sandwiched by the distal end portion of the first cylindrical portion 16A and a nut B. The nut B is coupled to the distal end portion of the first cylindrical portion 16A.

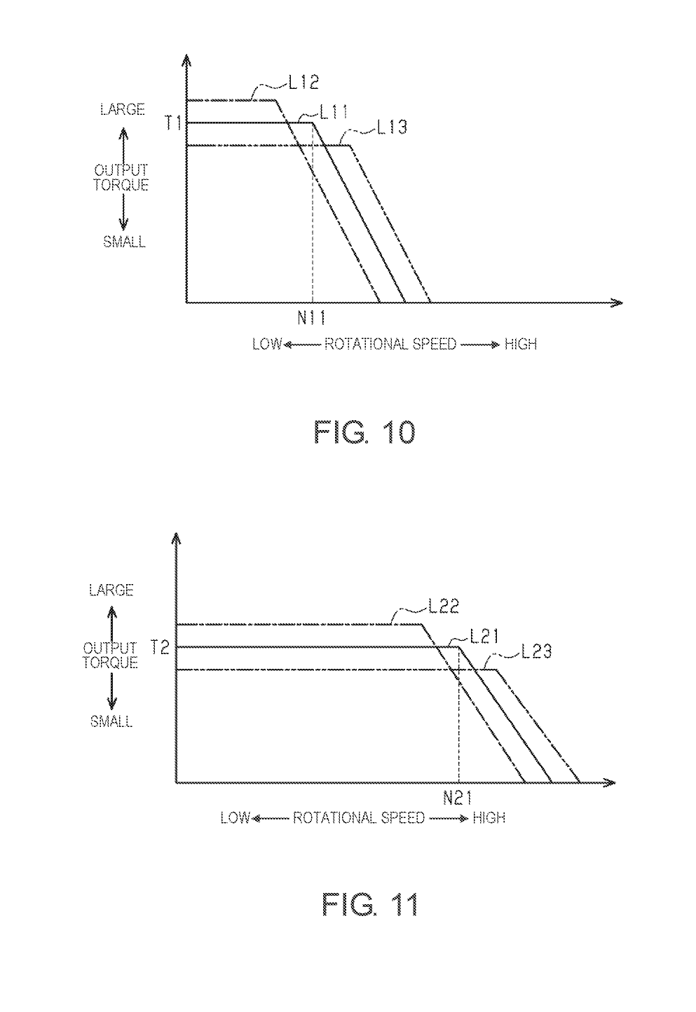

FIG. 10 shows an example of the output characteristics for each of three first motors 32 (refer to FIG. 9) having different output characteristics. The output characteristics L11 of the first motor 32, shown by the solid line graph in FIG. 10, is the same as, for example, the output characteristics of the first motor 32 of the first embodiment (refer to FIG. 5). The output characteristics L12 shown by the dashed line graph of the output characteristics of the plurality of the first motors 32 is such that the maximum value of the output torque is greater than the maximum value (output torque T1) of the output torque of the output characteristics L11, and the upper limit value of the rotational speed with which the maximum value of the output torque can be maintained is lower than the rotational speed N11 of the output characteristics L11. The output characteristics L13 shown by the double-dashed chain line graph of the output characteristics of the first motors 32 is such that the maximum value of the output torque is smaller than the maximum value (output torque T1) of the output torque of the output characteristics L11, and the upper limit value of the rotational speed with which the maximum value of the output torque can be maintained is higher than the rotational speed N11 of the output characteristics L11.

FIG. 11 shows an example of the output characteristics for each of three second motors 42 (refer to FIG. 9) having different output characteristics. The output characteristics L21 of the second motor 42, shown by the solid line graph in FIG. 11, is the same as, for example, the output characteristics of the second motor 42 of the first embodiment (refer to FIG. 5) The output characteristics L22, shown by the dashed line graph of the output characteristics of the plurality of the second motors 42, is such that the maximum value of the output torque is greater than the maximum value (output torque T2) of the output torque of the output characteristics L21, and the upper limit value of the rotational speed with which the maximum value of the output torque can be maintained is lower than the rotational speed N21 of the output characteristics L21 In one example, the maximum value of the output torque of the output characteristics L22 is smaller than the maximum value of the output torque of the output characteristics L13 of the first motor 32, and the upper limit value of the rotational speed with which the maximum value of the output torque of the output characteristics L21 can be maintained is higher than the upper limit value of the rotational speed with which the maximum value of the output torque of the output characteristics L13 can be maintained. The output characteristics L23, shown by the double-dashed chain line graph of the output characteristics of the second motors 42, is such that the maximum value of the output torque is smaller than the maximum value (output torque T2) of the output torque of the output characteristics L21, and the upper limit value of the rotational speed with which the maximum value of the output torque can be maintained is higher than the rotational speed N21 of the output characteristics L21.

In the drive unit 10, a motor that suits the preference of the user can be selected from the plurality of the motors having different characteristics. If a motor is selected, in which the output characteristics of at least one of the output characteristics L11 of the first motor 32 and the output characteristics L21 of the second motor 42 of the first embodiment is different, the prescribed rotational speed KN will be a rotational speed that is different from the prescribed rotational speed KN of the first embodiment (refer to FIG. 5). For example, the user sets the prescribed rotational speed KN each time when at least one of the first motor 32 and the second motor 42 is replaced with a motor having different output characteristics.

According to the second embodiment, the following actions and effects are obtained in addition to the same effects as the effects (1) and (2) of the first embodiment.

(3) A plurality of first motors 32 having different output characteristics can be attached to and detached from the first attaching portion 62. According to this configuration, the first motor 32 can be replaced according to a user request. Accordingly, an assist that suits the preference of the user can be easily achieved. The second attaching portion 64 exerts the same effect.

### MODIFICATIONS

The descriptions relating to each embodiment described above are examples of forms that the bicycle drive unit according to the present invention can take, and are not intended to limit the forms thereof. The bicycle drive unit according to the present invention can take the forms of the modifications of the above-described embodiments shown below, as well as forms that combine at least two modifications that are not mutually contradictory.

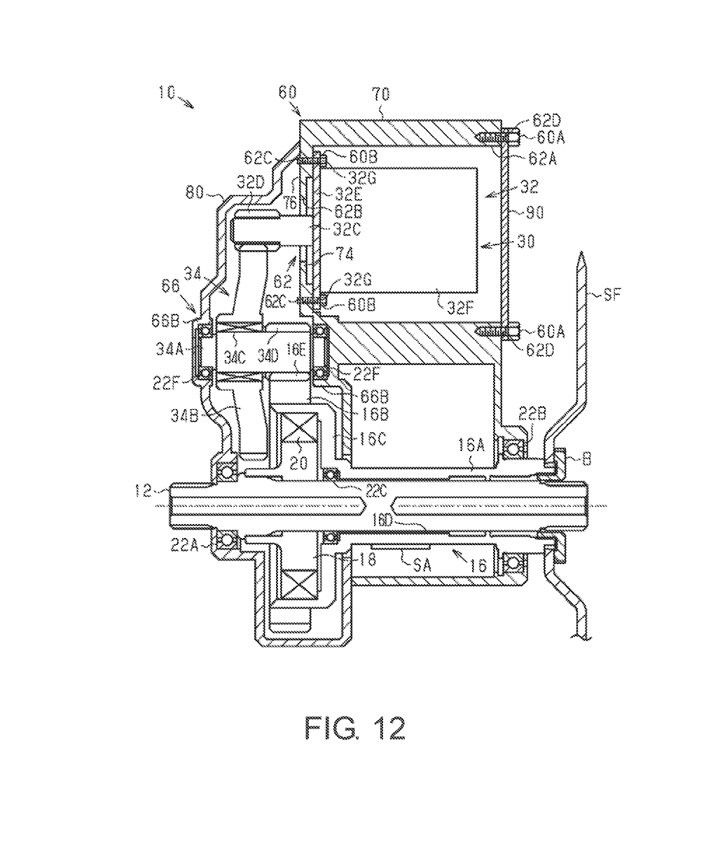

The compositional elements included in the drive unit 10 of the second embodiment can be freely changed. FIG. 12 is one example of a modification of the drive unit 10 of the second embodiment. This drive unit 10 comprises the first motor 32 and the first speed reducer 34, but does not comprise the second motor 42 and the second speed reducer 44. In another example, the drive unit 10 comprises the second motor 42 and the second speed reducer 44, but does not comprise the first motor 32 and the first speed reducer 34.

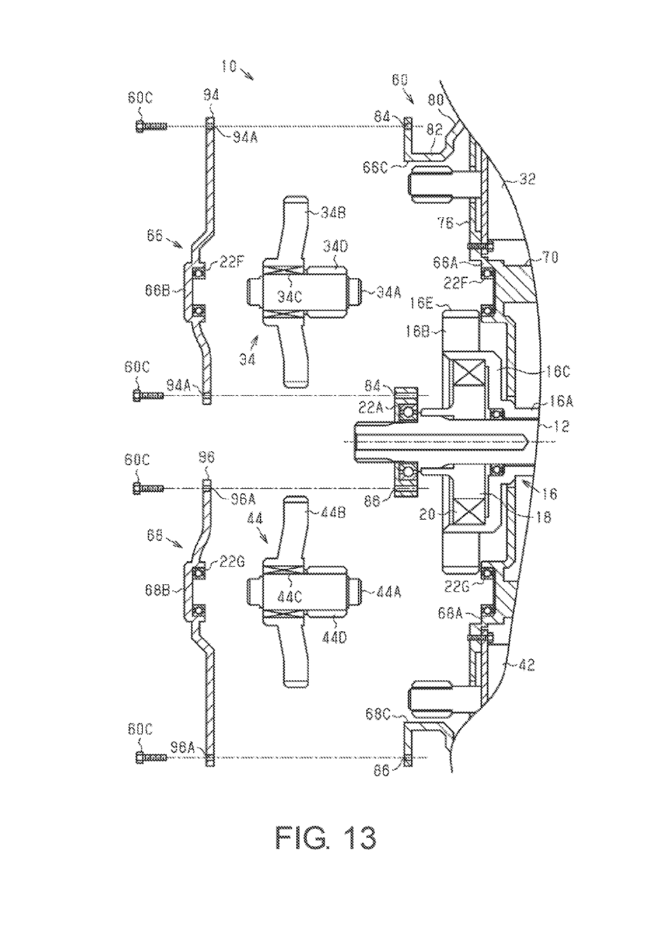

The structure of the third attaching portion 66 of the second embodiment can be freely changed. In one example, the third attaching portion 66 is configured so that one of a plurality of first speed reducers 34 having different speed reduction ratios can be selectively attached thereto/detached therefrom. FIG. 13 is a view relating to one example thereof. The sixth axle bearing 22F that supports the two ends of the rotational shaft 34A and the rotational shaft 34A are clearance fitted. The sixth axle bearing 22F is attached to each of the first holding portion 66A and the second holding portion 66B of the third attaching portion 66. The third attaching portion 66 comprises a third opening 66C that is provided in the outer wall 82 of the second housing 80. The first speed reducer 34 can be inserted in the third opening 66C. The third attaching portion 66 comprises a third cover body 94 that is configured to close the third opening 66C and a plurality of bolts 60C. The third cover body 94 comprises a second holding portion 66B and a plurality of holes 94A. The second housing 80 comprises a plurality of through-holes 84. The third cover body 94 can be attached to the second housing 80. The third cover body 94 is attached to the second housing 80 by the bolts 60C being inserted in the holes 94A and being coupled in the through-holes 84.

The fourth attaching portion 68 of the second embodiment can be changed in the same manner as the modification of the third attaching portion 66 described above. In one example, the fourth attaching portion 68 is configured so that one of a plurality of second speed reducers 44 having different speed reduction ratios can be selectively attached thereto/detached therefrom. FIG. 13 is a view relating to one example thereof. The seventh axle bearing 22G that supports the two ends of the rotational shaft 44A and the rotational shaft 44A are clearance fitted. The seventh axle bearing 22G is attached to each of the first holding portion 68A and the second holding portion 68B of the fourth attaching portion 68. The fourth attaching portion 68 comprises a fourth opening 68C that is provided in the outer wall 82 of the second housing 80. The second speed reducer 44 can be inserted in the fourth opening 68C. The fourth attaching portion 68 comprises a fourth cover body 96 that is configured to close the fourth opening 68C and a plurality of bolts 60C. The fourth cover body 96 comprises a second holding portion 68B and a plurality of holes 96A. The second housing 80 comprises a plurality of through-holes 86. The fourth cover body 96 can be attached to the second housing 80. The fourth cover body 96 is attached to the second housing 80 by the bolts 60C being inserted in the holes 96A and being coupled in the through-holes 86.

The structures of the third attaching portion 66 and the fourth attaching portion 68 of the embodiments can be freely changed. FIG. 13 is one example of a modification of the third attaching portion 66 and the fourth attaching portion 68. The third attaching portion 66 is configured so that the first speed reducer 34 can be attached thereto/detached therefrom. The fourth attaching portion 68 is configured so that the second speed reducer 44 can be attached to and detached from the fourth attaching portion 68. In another example, the third attaching portion 66 is configured so that the first speed reducer 34 can be attached to and detached from the third attaching portion 66, and the second speed reducer 44 is fixed to the fourth attaching portion 68. In yet another example, the fourth attaching portion 68 is configured so that the second speed reducer 44 can be attached to and detached from the fourth attaching portion 68, and the first speed reducer 34 is fixed to the third attaching portion 66.

Whether or not the drive unit 10 of each embodiment comprises the first speed reducer 34 and the second speed reducer 44 can be freely changed. In a first example, the drive unit 10 cannot comprise the first speed reducer 34. In this case, the first motor 32, the output unit 16, and the housings 14 and 60 are configured so that the first output shaft 32C of the first motor 32 is engaged with the gear 16E of the output unit 16. In a second example, the drive unit 10 cannot comprise the second speed reducer 44. In this case, the second motor 42, the output unit 16, and the housings 14 and 60 are configured so that the second output shaft 42C of the second motor 42 is engaged with the gear 16E of the output unit 16.

In each of the embodiments, the first assist unit 30 and the second assist unit 40 can be configured to be coupled with the end of the output unit 16 on the front sprocket SF side, in the axial direction of the crankshaft 12. In this case, the torque sensor 84 is provided between the connecting portion of the output unit 16 and the crankshaft 12 and the end of the output unit 16 on the front sprocket SF side. Here, the torque sensor 84 is configured to detect only the manual drive force even if the first motor 32 or the second motor 42 is driving. If the rotations of the first speed reducer 34 and the second speed reducer 44 are to be transmitted to the end of the output unit 16 on the front sprocket SF side in the first direction, for example in the drive unit 10 shown in FIGS. 3, 9 and 12, the positions of the motors and the speed reducers should be switched.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section.” “portion,” “member” or “element” when used in the singular can have the dual meaning of a single part or a plurality of parts unless otherwise stated.

Also it will be understood that although the terms “first” and “second” may be used herein to describe various components these components should not be limited by these terms. These terms are only used to distinguish one component from another. Thus, for example, a first component discussed above could be termed a second component and vice versa without departing from the teachings of the present invention. The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A bicycle drive unit comprising:
a housing rotatably supporting a crankshaft;
an output unit provided in the housing and to which a rotation of the crankshaft is transmitted;
a first motor provided in the housing to assist a manual drive force without changing a ratio of a rotational speed of the output unit relative to a rotational speed of the crankshaft; and
a second motor provided in the housing to assist the manual drive force without changing the ratio of the rotational speed of the output unit relative to the rotational speed of the crankshaft.

2. The bicycle drive unit according to claim 1, wherein
the first motor and the second motor apply a drive force to the output unit.

3. The bicycle drive unit according to claim 1, further comprising
a first speed reducer configured to decelerate a rotational speed of the first motor that is transmitted to the output unit.

4. The bicycle drive unit according to claim 1, further comprising
a second speed reducer configured to decelerate a rotational speed of the second motor that is transmitted to the output unit.

5. The bicycle drive unit according to claim 4, wherein
a first speed reducer configured to decelerate a rotational speed of the first motor that is transmitted to the output unit, and
a speed reduction ratio of the first speed reducer and a speed reduction ratio of the second speed reducer are different from each other.

6. The bicycle drive unit according to claim 1, wherein
output characteristics of the first motor and output characteristics of the second motor are different from each other.

7. The bicycle drive unit according to claim 6, wherein
the output characteristics of the first motor and the output characteristics of the second motor are different in output torque characteristics that corresponds to a rotational speed.

8. The bicycle drive unit according to claim 1, further comprising
a controller being configured to the first motor and the second motor according to the manual drive force that is applied to the crankshaft, the controller being configured to selectively and individually operate the first motor and the second motor.

9. The bicycle drive unit according to claim 8, wherein
the controller is configured to selectively operate the first motor and the second motor, based on at least one of the rotational speed of the crankshaft and a vehicle speed.

10. The bicycle drive unit according to claim 9, wherein
the controller is configured to operate the first motor according to the manual drive force while the rotational speed of the crankshaft or the vehicle speed is less than a prescribed speed, and configured to operate the second motor according to the manual drive force while the rotational speed of the crankshaft or the vehicle speed is greater than or equal to the prescribed speed.

11. The bicycle drive unit according to claim 10, wherein
the controller is configured to control an output torque of the first and second motors such that the output torque of the first motor is greater than an output torque of the second motor while a rotational speed of the first motor is less than a prescribed rotational speed and a rotational speed of the second motor is less than a prescribed rotational speed; and
the controller is configured to control an output torque of the first and second motors such that the output torque of the first motor is less than or equal to the output torque of the second motor while the rotational speed of the first motor is greater than or equal to the prescribed rotational speed of the first motor, the rotational speed of the second motor is greater than or equal to the prescribed rotational speed of the second motor.

12. The bicycle drive unit according to claim 1, wherein
the housing comprises a first attaching portion to which the first motor is attached and a second attaching portion to which the second motor is attached; and
the first attaching portion is configured so that one of a plurality of the first motors having different output characteristics can be selectively attached to the housing and detached from the housing.

13. The bicycle drive unit according to claim 12, wherein
the first attaching portion is configured so that the first motor can be attached to the housing and detached from the housing from outside of the housing.

14. A bicycle drive unit comprising:
a housing configured to rotatably support a crankshaft,
the housing comprises a first attaching portion to which a first motor is attached that assists a manual drive force, and
the first attaching portion is configured so that one of a plurality of the first motors having different output characteristics can be selectively attached to the housing and detached from the housing.

15. The bicycle drive unit according to claim 14, wherein
the first attaching portion is configured so that the first motor can be attached to the housing and detached from the housing from outside of the housing.

16. The bicycle drive unit according to claim 14, wherein
the housing further comprises a second attaching portion to which can be attached a second motor that assists a manual drive force, and
the second attaching portion is configured so that one of a plurality of the second motors having different output characteristics can be selectively attached to the housing and detached from the housing.

17. The bicycle drive unit according to claim 16, wherein
the second attaching portion is configured so that the second motor can be attached to the housing and detached from the housing from outside of the housing.

18. The bicycle drive unit according to claim 16, further comprising
an output unit to which a rotation of the crankshaft is transmitted,
the first motor and the second motor apply a drive force to the output unit.

19. The bicycle drive unit according to claim 18, further comprising
a third attaching portion to which is attached a first speed reducer that decelerates a rotational speed of the first motor that is transmitted to the output unit,
the third attaching portion being configured so that one of a plurality of first speed reducers having different speed reduction ratios can be selectively attached to the housing and detached from the housing.

20. The bicycle drive unit according to claim 18, further comprising
a fourth attaching portion to which is attached a second speed reducer that decelerates a rotational speed of the second motor and that is transmitted to the output unit, wherein
the fourth attaching portion is configured so that one of a plurality of second speed reducers having different speed reduction ratios can be selectively attached to the housing; detached from the housing.

21. The bicycle drive unit according to claim 14, wherein
the first attaching portion comprises an opening provided in a wall of the housing, and a cover body for closing the opening attached thereto.
